(19) United States
(12) Patent Application Publication
(10) Pub. No.: US 2006/0193537 A1
(43) Pub. Date: Aug. 31, 2006

(54) Interpolation filter and image signal processing device

(75) Inventors: Keiichi Tsumura, Hyogo (JP); Toshiyuki Nakashima, Osaka (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/353,147

(22) Filed: Feb. 14, 2006

(30) Foreign Application Priority Data
Feb. 25, 2005 (JP) 2005-051509

(51) Int. Cl. G06K 9/32

(52) U.S. Cl. 382/300

(57) ABSTRACT

An interpolation filter performs an interpolation operation on an image signal. The interpolation filter employs a third-order interpolation, which can be realized with a smaller circuit scale. The interpolation function f(x), representing a coefficient by which a value of a pixel at a distance of x from the interpolated object position is multiplied, is given by the following expression.
fᵢ(x)=a|x|³+bᵢ|x|²+cᵢ|x|+dᵢ(xᵢ≦|x|<xᵢ₊₁)(i=0, 1, . . . , n−1, x₀=0, xₙ=2)
f₀(0)≠1
fᵢ(xᵢ₊₁)=fᵢ₊₁(xᵢ₊₁)
fₙ(2)=0
f(1+k)+f(k)+f(1−k)+f(2−k)=1 (where k is a decimal portion of a coordinate of the interpolated object position)

### BACKGROUND OF THE INVENTION

1. Field of the Invention

The present invention relates to an interpolation filter for use in image signal processing performed by image signal processing devices such as digital still cameras, video cameras and television sets.

2. Description of the Background Art

Conventional image interpolation methods include a two-point interpolation using a linear interpolation function, for example. Another method with a higher precision is a four-point interpolation using a third-order convolution interpolation function. A four-point interpolation using a fourth-order interpolation function has been proposed in the art as an interpolation method with an even higher precision (see Patent Document 1).

Patent Document 1: Japanese Laid-Open Patent Publication No. 11-168664

FIGS. 8A, 8B, 9A and 9B are graphs showing the characteristics of conventional interpolation methods. FIGS. 8A and 8B are directed to an example using a linear interpolation function, and FIGS. 9A and 9B are directed to an example using a third-order convolution interpolation function. FIGS. 8A and 9A are frequency-gain characteristics obtained in a research by the present inventors. The horizontal axis represents the frequency of the subject image, given in a ratio with respect to the frequency corresponding to the pixel pitch being one. The vertical axis represents the gain. A characteristics graph is plotted for each of the interpolated object positions k (k=0.0, 0.1, 0.2, 0.3, 0.4 and 0.5). FIGS. 8B and 9B show the interpolation functions used in the research.

As can be seen from FIGS. 8A, 8B, 9A and 9B, there are significant variations in frequency characteristics among the different interpolated object positions with the conventional interpolation methods. In other words, the gain will vary depending on the position at which the image is interpolated even at the same subject image frequency. For image processing, characteristics at frequencies of up to about 0.2 are particularly important, and gain variations in this frequency range will cause problems such as image unevenness.

Moreover, a fourth-order interpolation requires a larger number of multipliers, thus resulting in a larger circuit scale.

### SUMMARY OF THE INVENTION

It is therefore an object of the present invention to provide an interpolation filter employing a third-order interpolation, which can be realized with a smaller circuit scale, in which there are little variations in frequency characteristics among different interpolated pixel positions.

The present invention provides an interpolation filter for performing an interpolation operation on an image signal, wherein: the interpolation filter outputs an output value, as a signal value at an interpolated object position, wherein the output value is obtained by multiplying each of signal values of pixels within a two-pixel distance from the interpolated object position by a coefficient and adding up the obtained products together; and an interpolation function f(x), representing a coefficient by which a value of a pixel at a distance of x from the interpolated object position is multiplied, is given by the following expression (where f(x) is defined for each of n intervals obtained by dividing 0≦|x|≦2 into n portions, and k is a decimal portion of a coordinate of the interpolated object position).
fᵢ(x)=aᵢ|x|³+bᵢ|x|²+cᵢ|x|+dᵢ(xᵢ≦|x|<xᵢ₊₁)(i=0, 1, . . . , n−1, x₀=0, xₙ=2)
f₀(0)≠1
fᵢ(xᵢ₊₁)=fᵢ₊₁(xᵢ₊₁)
fₙ(2)=0

Moreover, the interpolation function f(x) is determined so that, where the interpolated object position is shifted from P1 toward P2 by k with respect to a sequence of uninterpolated pixel coordinates P0, P1, P2 and P3, the following expression always holds true in the interval of 0≦k≦1. The value k being one equals the pixel pitch.
f(1+k)+f(k)+f(1−k)+f(2−k)=1

where 1+k corresponds to the distance from the interpolated object position to P0, k corresponds to the distance from the interpolated object position to P1, 1−k corresponds to the distance from the interpolated object position to P2, and 2−k corresponds to the distance from the interpolated object position to P3. This means that the sum of the coefficients by which pixel values are multiplied before they are added up together by the interpolation filter is always one, irrespective of the interpolated object position.

Preferably, the interpolation function f(x) of the present invention is determined so that where a frequency of a subject image is ⅕ or less of a frequency corresponding to a pixel pitch, a variation in gain according to the interpolated object position falls within 5% of a maximum gain value for the frequency. Note that the gain G(k) is given by the following expression. In the expression, ν is the subject image frequency, and i is the imaginary unit. Note that ν is scaled with the frequency corresponding to the pixel pitch being one.
G(k)=|f(1+k)+f(k)×exp(2πνi)+f(1−k)×exp(4πνi)+f(2−k)×exp(6πνi)|

FIGS. 10A and 10B are graphs showing the characteristics of an interpolation method of the present invention. FIG. 10A shows an example of the frequency-gain. characteristics, and FIG. 10B shows an example of the interpolation function of the present invention. With respect to the vertical axis, the horizontal axis and how the graphs are plotted, the figures are similar to FIGS. 8A, 8B, 9A and 9B.

As can be seen from FIGS. 10A and 10B, across the frequency range where the frequency is about 0.2 or less, there are little variations in gain among different interpolated object positions, and substantially the same characteristics are obtained for the interpolated object positions. This indicates that the present invention realizes an interpolation filter with little variations in frequency characteristics among different interpolated pixel positions.

Thus, the present invention realizes an interpolation filter employing a third-order interpolation, which can be realized with a smaller circuit scale, in which there are little variations in frequency characteristics among different interpolated pixel positions.

### BRIEF DESCRIPTION OF THE DRAWINGS

FIG. 1 is a block diagram showing a configuration of an image signal processing device including an interpolation filter according to an embodiment of the present invention.

FIG. 2 shows the image coordinates before an interpolation operation in a 2× zooming operation.

FIG. 3 shows the image coordinates after an interpolation operation in a 2× zooming operation.

FIG. 4 shows the coordinate data used for an interpolation operation in a 2× zooming operation.

FIG. 5 shows the image coordinates before an interpolation operation in a camera shake compensation operation.

FIG. 6 shows the image coordinates after an interpolation operation in a camera shake compensation operation.

FIG. 7 shows the coordinate data used for an interpolation operation in a camera shake compensation operation.

FIGS. 8A and 8B are graphs showing the characteristics of a conventional interpolation method employing a linear interpolation function.

FIGS. 9A and 9B are graphs showing the characteristics of a conventional interpolation method employing a third-order convolution interpolation function.

FIGS. 10A and 10B are graphs showing the characteristics of an interpolation method of the present invention.

### DETAILED DESCRIPTION OF THE INVENTION

An embodiment of the present invention will now be described with reference to the drawings.

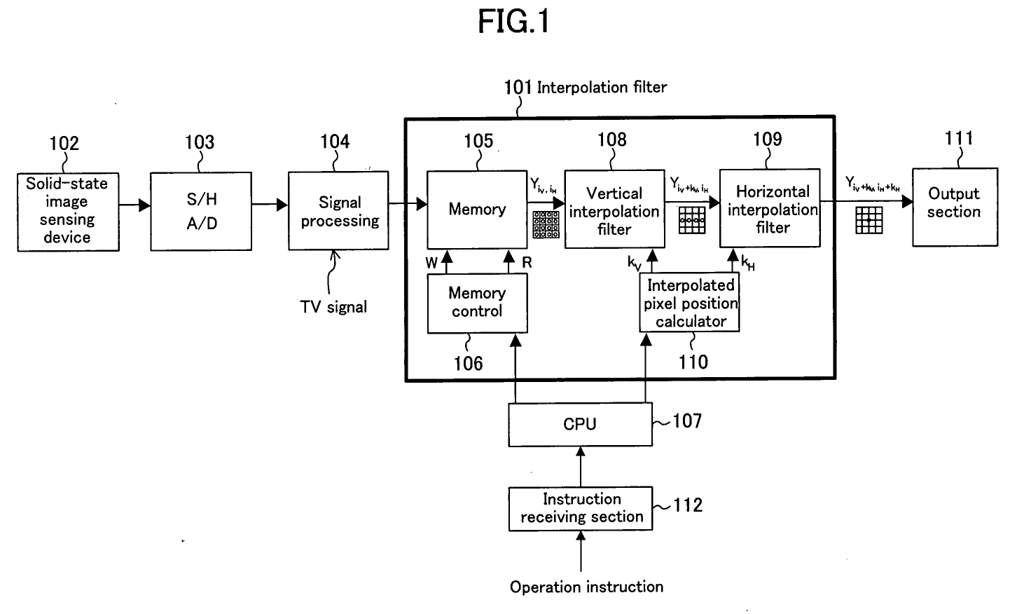

FIG. 1 is a block diagram showing a configuration of an image signal processing device including an interpolation filter according to an embodiment of the present invention. Referring to FIG. 1, a solid-state image sensing device 102 outputs an obtained image signal. An S/H A/D section 103 samples and holds, and performs an A/D conversion on, the output signal from the solid-state image sensing device 102. A signal processing section 104 performs signal processing operations, e.g., producing the luminance and the color, on the output signal from the S/H A/D section 103. An interpolation filter 101 performs an interpolation operation on the image signal from the signal processing section 104 for zooming, camera shake compensation, etc. The interpolated signal is output from an output section 111.

Specifically, the image signal processing device of FIG. 1 may be, for example, a digital still camera or a video camera. The interpolation filter of the present invention can also be used in other image signal processing devices such as television sets. For example, where the present invention is used in a television set, a received TV signal is given to the signal processing section 104.

The configuration and the operation of the interpolation filter 101 will be described.

The image signal output from the signal processing section 104 is written to a memory 105. Based on an operation instruction given to an instruction receiving section 112, a CPU 107 produces information of a zoom factor or a camera shake compensation vector, and sends the produced information to a memory control section 106 and an interpolated pixel position calculator 110. Based on the information sent from the CPU 107, the memory control section 106 reads out the signal value of each pixel from the memory 105 by performing memory control operations such as a read address processing operation and a read timing processing operation.

Also based on the information sent from the CPU 107, the interpolated pixel position calculator 110 calculates the interpolated object position. A vertical interpolation filter 108 performs an interpolation operation for each interpolated object position in the vertical direction by using data of a total of 16 pixels, i.e., four pixels horizontal by four pixels vertical read out from the memory 105, to obtain four pixels in the horizontal direction each interpolated from four pixels in the vertical direction. Then, a horizontal interpolation filter 109 performs an interpolation operation for interpolated object position in the horizontal direction by using the four pixels in the horizontal direction output from the vertical interpolation filter 108, to obtain a pixel value interpolated both in the vertical and horizontal direction.

For the vertical and horizontal interpolation, the present embodiment employs a function represented by the expression below as an interpolation function f(x) representing the coefficient by which the value of a pixel that is at a distance of x from an interpolated object position is multiplied. In the expression, f(x) is defined for each of n intervals obtained by dividing 0≦|x|≦2 into n portions, and k is the decimal portion of the coordinate of the interpolated object position.
f(x)=aᵢ|x|³+bᵢ|x|²+cᵢ|x|+dᵢ(xᵢ≦|x|<xᵢ₊₁)(i=0, 1, . . . , n−1, x₀=0, xₙ=2)
f₀(0)≠1
fᵢ(xᵢ₊₁)=fᵢ₊₁(xᵢ₊₁)
fₙ(2)=0
f(1+k)+f(k)+f(1−k)+f(2−k)=1(0≦k≦1)

For example, where n=2 and x₁=1, the expression for the vertical interpolation and that for the horizontal interpolation will be as shown in Expressions 1 and 2 below, respectively.

$${i}_{V} = 0 , 1 , 2 , ⋯ \\ {i}_{H} = 0 , 1 , 2 , ⋯ \\ 0 ≦ {k}_{V} < 1 \\ 0 ≦ {k}_{H} < 1 \\ \begin{matrix}{Y}_{{i}_{V} + {k}_{V} , {i}_{H} - 1} = \{ {{a}_{1} ( 1 + {k}_{V} )}^{3} + {{b}_{1} ( 1 + {k}_{V} )}^{2} + {c}_{1} ( 1 + {k}_{V} ) + {d}_{1} \} {Y}_{{i}_{v} - 1 , {i}_{H} - 1} + \\ \{ {a}_{0} {k}_{V}^{3} + {b}_{0} {k}_{V}^{2} + {c}_{0} {k}_{V} + {d}_{0} \} {Y}_{{i}_{V} , {i}_{H} - 1} + \\ \{ {{a}_{0} ( 1 - {k}_{V} )}^{3} + {{b}_{0} ( 1 - {k}_{V} )}^{2} + {c}_{0} ( 1 - {k}_{V} ) + {d}_{0} \} {Y}_{{i}_{V} + 1 , {i}_{H} - 1} + \\ \{ {{a}_{1} ( 2 - {k}_{V} )}^{3} + {{b}_{1} ( 2 - {k}_{V} )}^{2} + {c}_{1} ( 2 - {k}_{V} ) + {d}_{1} \} {Y}_{{i}_{V} + 2 , {i}_{H} - 1}\end{matrix} \\ Pixel data after vertical interpolation \\ {Y}_{{i}_{V} + {k}_{V} , {i}_{H} - 1} \\ Pixel data before interpolation \\ {Y}_{{i}_{V} - 1 , {i}_{H} - 1} , {Y}_{{i}_{V} , {i}_{H} - 1} , {Y}_{{i}_{V} + 1 , {i}_{H} - 1} , {Y}_{{i}_{V} + 2 , {i}_{H} - 1} \\ \begin{matrix}{Y}_{{i}_{V} + {k}_{V} , {i}_{H}} = \{ {{a}_{1} ( 1 + {k}_{V} )}^{3} + {{b}_{1} ( 1 + {k}_{V} )}^{2} + {c}_{1} ( 1 + {k}_{V} ) + {d}_{1} \} {Y}_{{i}_{v} - 1 , {i}_{H}} + \\ \{ {a}_{0} {k}_{V}^{3} + {b}_{0} {k}_{V}^{2} + {c}_{0} {k}_{V} + {d}_{0} \} {Y}_{{i}_{V} , {i}_{H}} + \\ \{ {{a}_{0} ( 1 - {k}_{V} )}^{3} + {{b}_{0} ( 1 - {k}_{V} )}^{2} + {c}_{0} ( 1 - {k}_{V} ) + {d}_{0} \} {Y}_{{i}_{V} + 1 , {i}_{H}} + \\ \{ {{a}_{1} ( 2 - {k}_{V} )}^{3} + {{b}_{1} ( 2 - {k}_{V} )}^{2} + {c}_{1} ( 2 - {k}_{V} ) + {d}_{1} \} {Y}_{{i}_{V} + 2 , {i}_{H}}\end{matrix} \\ Pixel data after vertical interpolation \\ {Y}_{{i}_{V} + {k}_{V} , {i}_{H}} \\ Pixel data before interpolation \\ {Y}_{{i}_{V} - 1 , {i}_{H}} , {Y}_{{i}_{V} , {i}_{H}} , {Y}_{{i}_{V} + 1 , {i}_{H}} , {Y}_{{i}_{v} + 2 , {i}_{H}} \\ \begin{matrix}{Y}_{{i}_{V} + {k}_{V} , {i}_{H} + 1} = \{ {{a}_{1} ( 1 + {k}_{V} )}^{3} + {{b}_{1} ( 1 + {k}_{V} )}^{2} + {c}_{1} ( 1 + {k}_{V} ) + {d}_{1} \} {Y}_{{i}_{v} - 1 , {i}_{H} + 1} + \\ \{ {a}_{0} {k}_{V}^{3} + {b}_{0} {k}_{V}^{2} + {c}_{0} {k}_{V} + {d}_{0} \} {Y}_{{i}_{V} , {i}_{H} + 1} + \\ \{ {{a}_{0} ( 1 - {k}_{V} )}^{3} + {{b}_{0} ( 1 - {k}_{V} )}^{2} + {c}_{0} ( 1 - {k}_{V} ) + {d}_{0} \} {Y}_{{i}_{V} + 1 , {i}_{H} + 1} + \\ \{ {{a}_{1} ( 2 - {k}_{V} )}^{3} + {{b}_{1} ( 2 - {k}_{V} )}^{2} + {c}_{1} ( 2 - {k}_{V} ) + {d}_{1} \} {Y}_{{i}_{V} + 2 , {i}_{H} + 1}\end{matrix} \\ Pixel data after vertical interpolation \\ {Y}_{{i}_{V} + {k}_{V} , {i}_{H} + 1} \\ Pixel data before interpolation \\ {Y}_{{i}_{V} - 1 , {i}_{H} + 1} , {Y}_{{i}_{V} , {i}_{H} + 1} , {Y}_{{i}_{V} + 1 , {i}_{H} + 1} , {Y}_{{i}_{V} + 2 , {i}_{H} + 1} \\ \begin{matrix}{Y}_{{i}_{V} + {k}_{V} , {i}_{H} + 2} = \{ {{a}_{1} ( 1 + {k}_{V} )}^{3} + {{b}_{1} ( 1 + {k}_{V} )}^{2} + {c}_{1} ( 1 + {k}_{V} ) + {d}_{1} \} {Y}_{{i}_{v} - 1 , {i}_{H} + 2} + \\ \{ {a}_{0} {k}_{V}^{3} + {b}_{0} {k}_{V}^{2} + {c}_{0} {k}_{V} + {d}_{0} \} {Y}_{{i}_{V} , {i}_{H} + 2} + \\ \{ {{a}_{0} ( 1 - {k}_{V} )}^{3} + {{b}_{0} ( 1 - {k}_{V} )}^{2} + {c}_{0} ( 1 - {k}_{V} ) + {d}_{0} \} {Y}_{{i}_{V} + 1 , {i}_{H} + 2} + \\ \{ {{a}_{1} ( 2 - {k}_{V} )}^{3} + {{b}_{1} ( 2 - {k}_{V} )}^{2} + {c}_{1} ( 2 - {k}_{V} ) + {d}_{1} \} {Y}_{{i}_{V} + 2 , {i}_{H} + 2}\end{matrix} \\ Pixel data after vertical interpolation \\ {Y}_{{i}_{V} + {k}_{V} , {i}_{H} + 2} \\ Pixel data before interpolation \\ {Y}_{{i}_{V} - 1 , {i}_{H} + 2} , {Y}_{{i}_{V ,} {i}_{H} + 2} , {Y}_{{i}_{V} + 1 , {i}_{H} + 2} , {Y}_{{i}_{V} + 2 , {i}_{H} + 2} \qquad EXPRESSION 1$$

$${i}_{V} = 0 , 1 , 2 , ⋯ \\ {i}_{H} = 0 , 1 , 2 , ⋯ \\ 0 ≦ {k}_{V} < 1 \\ 0 ≦ {k}_{H} < 1 \\ \begin{matrix}{Y}_{{i}_{V} + {k}_{V} , {i}_{H} + {k}_{H}} = \{ {{a}_{1} ( 1 + {k}_{H} )}^{3} + {{b}_{1} ( 1 + {k}_{H} )}^{2} + {c}_{1} ( 1 + {k}_{H} ) + {d}_{1} \} {Y}_{{i}_{v} + {k}_{v} , {i}_{H} - 1} + \\ \{ {a}_{0} {k}_{H}^{3} + {b}_{0} {k}_{H}^{2} + {c}_{0} {k}_{H} + {d}_{0} \} {Y}_{{i}_{V} + {k}_{V} , {i}_{H}} + \\ \{ {{a}_{0} ( 1 - {k}_{H} )}^{3} + {{b}_{0} ( 1 - {k}_{H} )}^{2} + {c}_{0} ( 1 - {k}_{H} ) + {d}_{0} \} {Y}_{{i}_{V} + {k}_{V} , {i}_{H} + 1} + \\ \{ {{a}_{1} ( 2 - {k}_{H} )}^{3} + {{b}_{1} ( 2 - {k}_{H} )}^{2} + {c}_{1} ( 2 - {k}_{H} ) + {d}_{1} \} {Y}_{{i}_{V} + {k}_{V} , {i}_{H} + 2}\end{matrix} \\ Pixel data after vertical interpolation \\ {Y}_{{i}_{V} + {k}_{V} , {i}_{H} + {k}_{H}} \\ Pixel data before interpolation \\ {Y}_{{i}_{V} + {k}_{V} , {i}_{H} - 1} , {Y}_{{i}_{V} + {k}_{V} , {i}_{H}} , {Y}_{{i}_{V} + {k}_{V} , {i}_{H} + 1} , {Y}_{{i}_{V} + {k}_{V} , {i}_{H} + 2} \qquad EXPRESSION 2$$

Specifically, the vertical interpolation filter 108 calculates Expression 1 using the interpolated object position k_{V} in the vertical direction calculated by the interpolated pixel position calculator 110, to obtain four pixels in the horizontal direction each interpolated in the vertical direction. Then, the horizontal interpolation filter 109 calculates Expression 2 using the interpolated object position k_{H} in the horizontal direction calculated by the interpolated pixel position calculator 110, to obtain a pixel value interpolated both in the vertical and horizontal direction.

Moreover, expressions corresponding to
f(1+k)+f(k)+f(1−k)+f(2−k)=1 (0≦k≦1)
are as follows.
3a₀+2b₀+9a₁+2b₁=0
a₀+b₀+c₀+2d₀+9a₁+5b₁+3c₁+2d₁=1

Specific image processing operations using the interpolation operation will now be described.

Zooming Operation

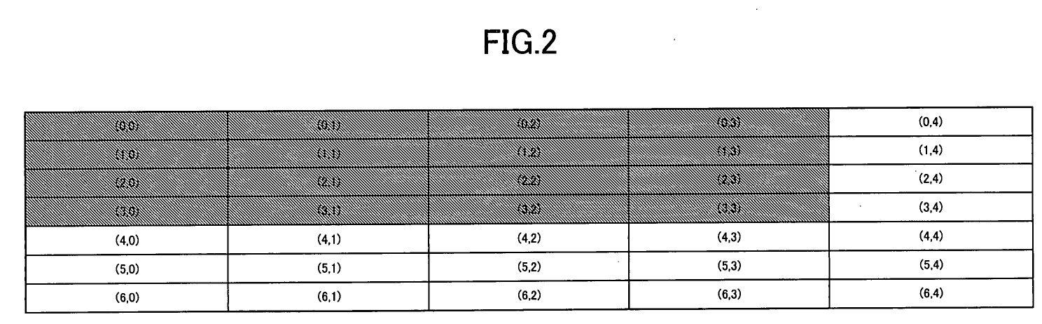

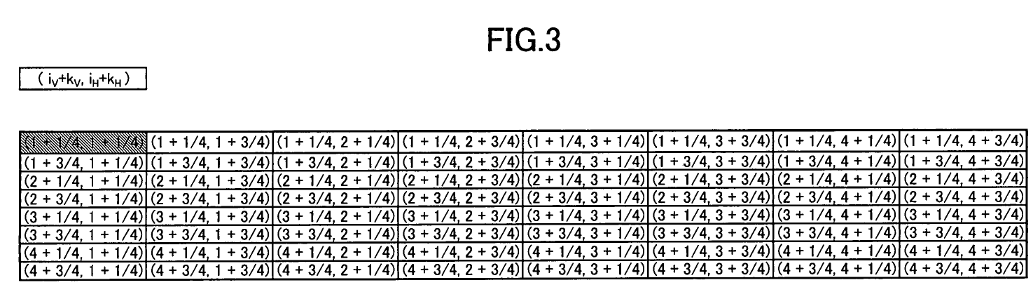

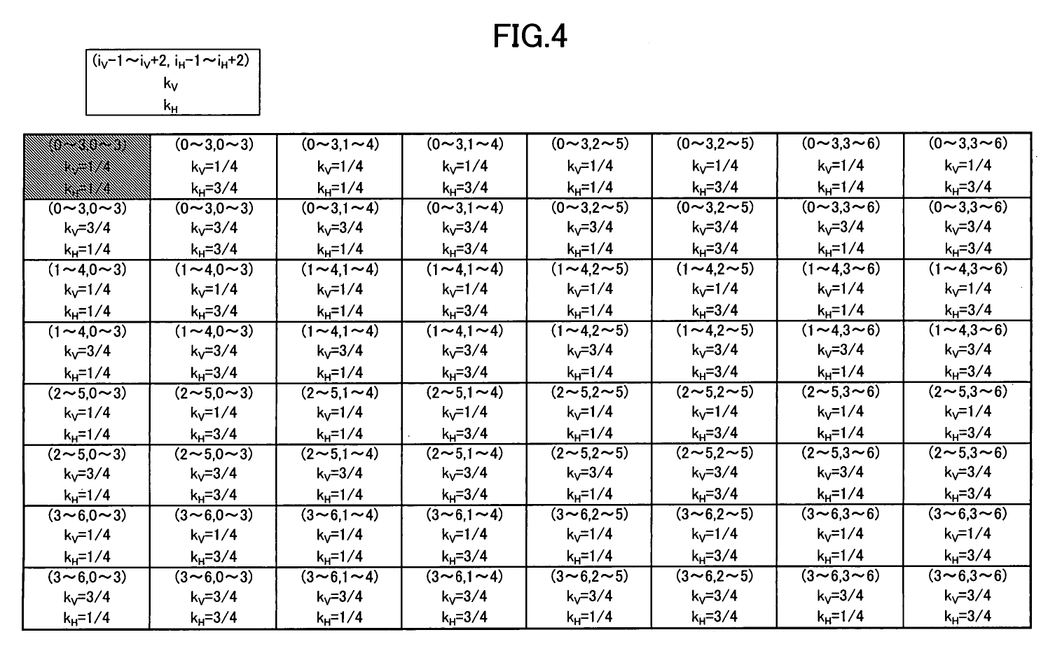

As an example, a 2× zooming operation will now be described. FIG. 2 shows the image coordinates before an interpolation operation, FIG. 3 shows the image coordinates after an interpolation operation, and FIG. 4 shows the coordinate data used for an interpolation operation. Assume that an interpolation operation for 2× zooming is performed by using the image of FIG. 2 to obtain the 8×8 image of FIG. 3. In FIG. 3, the coordinates in each box are obtained by converting interpolated coordinates into uninterpolated coordinate values.

First, an interpolation operation is performed for the upper left pixel (hatched box) of FIG. 3. The interpolation operation is performed by using the coordinate values and the interpolated object positions (the decimal portions of the coordinates) in the corresponding box (hatched box) in FIG. 4. Specifically, Expressions 1 and 2 are calculated using the pixel values of the pixels (0, 0) to (3, 3) (hatched boxes) in FIG. 2, the vertical interpolated object position k_{V}=¼ therefor, and the horizontal interpolated object position k_{H}=¼ therefor.

Then, the interpolation operation is performed for the next pixel to the right from the upper left pixel. In the interpolation operation, Expressions 1 and 2 are calculated using the pixel data of the pixels (0 to 3, 0 to 3) and the interpolated object positions k_{V}=¼ and k_{H}=¾ therefor specified in the corresponding box in FIG. 4. Then, the interpolation operation is performed based on Expressions 1 and 2 for the next pixel to the right from the second pixel by using the pixel data of the pixels (0 to 3, 1 to 4) and the interpolated object positions k_{V}=¼ and k_{H}=¼ therefor specified in the corresponding box in FIG. 4. This is repeated for the rest of the pixels to be interpolated, thereby obtaining a 2× zoomed image of 8×8 pixels as shown in FIG. 3.

Generally, a zooming operation can be performed as follows. Assume that a zooming operation with a magnification factor of n_{V} in the vertical direction and a magnification factor of n_{H} in the horizontal direction is performed.

First, an interpolation in the vertical direction is performed. Assume that the vertical size of the image to be obtained is m_{V} pixels. The vertical pixel pitch P_{V} of the interpolated pixels is given by the following expression.
P_{V}=1/n_{V}

Where the vertical start position of the interpolated pixels is s_{V}, the interpolated object pixel position P_{iV} is obtained as follows.
P_{iV}=s_{V}+p_{V}×i_{V}(iᵥ=0, 1, 2, 3, . . . , m_{V}−1)

Assume that the integer portion of P_{iV} is P_{int iV}, and the decimal portion thereof is P_{dec iV}. The data of the following coordinates
P_{int iV}−1, P_{int iV}, Pint iV+1, P_{int iV}+2
are used as the original data of pixels to be interpolated. Let the respective pixel data be represented as
Y_{iV-1}, Y_{iV}, Y_{iV+1}, Y_{iV+2}, and
let k_{V}=P_{dec iV}.
In the vertical interpolation, Expression 1 is calculated using these values. Repeating this for i_{V}=0, 1, 2, 3, . . . , m_{V}−1 yields an n_{V}× zoomed image.

Next, an interpolation in the horizontal direction is performed. Assume that the horizontal size of the image to be obtained is m_{H} pixels. The horizontal pixel pitch P_{H} of the interpolated pixels is given by the following expression.
P_{H}=1/n_{H}

Where the horizontal start position of the interpolated pixels is s_{H}, the interpolated object pixel position P_{iH} is obtained as follows.
P_{iH}=s_{H}+p_{H}×i_{H}(i_{H}=0, 1, 2, 3, . . . , m_{H}−1)

Assume that the integer portion of P_{iH} is P_{int iH}, and the decimal portion thereof is P_{dec iH}. The data of the following coordinates
P_{int iH}−1, P_{int iH}, P_{int iH}+1, P_{int iH}+2
are used as the original data of pixels to be interpolated. Let the respective pixel data be represented as
Y_{iH-1}, Y_{iH}, Y_{iH+1}, Y_{iH+2}, and
let k_{H}=P_{dec iH}.

In the horizontal interpolation, Expression 2 is calculated using these values. Repeating this for i_{H}=0, 1, 2, 3, . . . , m_{H}−1 yields an n_{H}× zoomed image.

Camera Shake Compensation

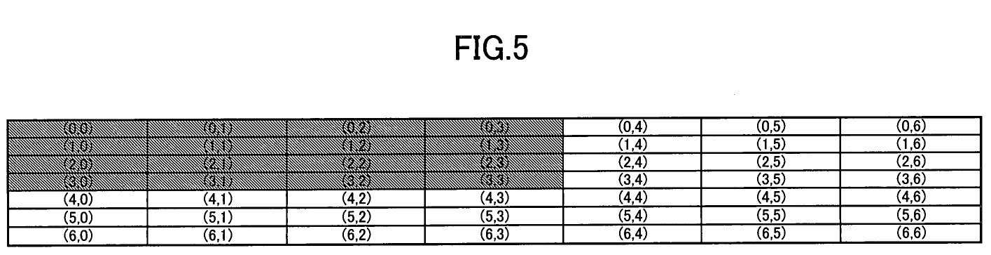

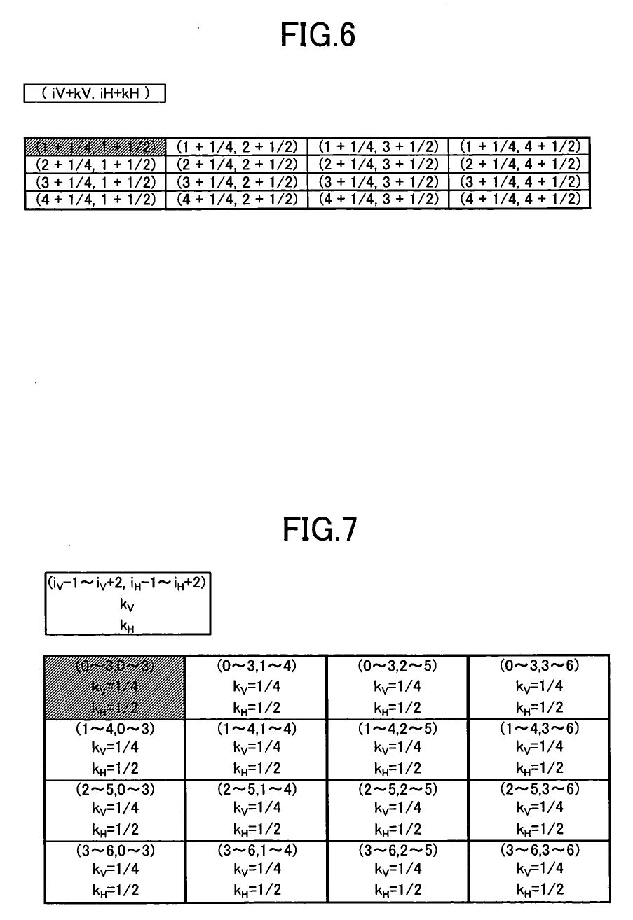

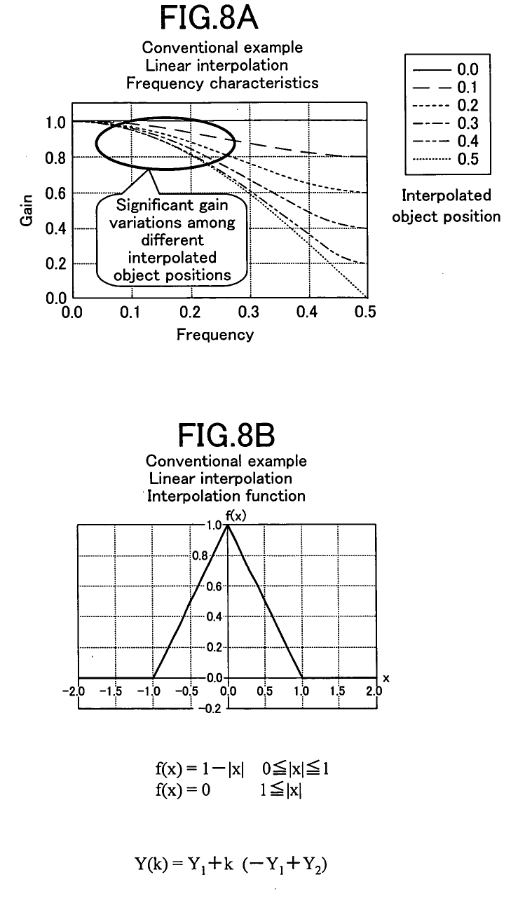

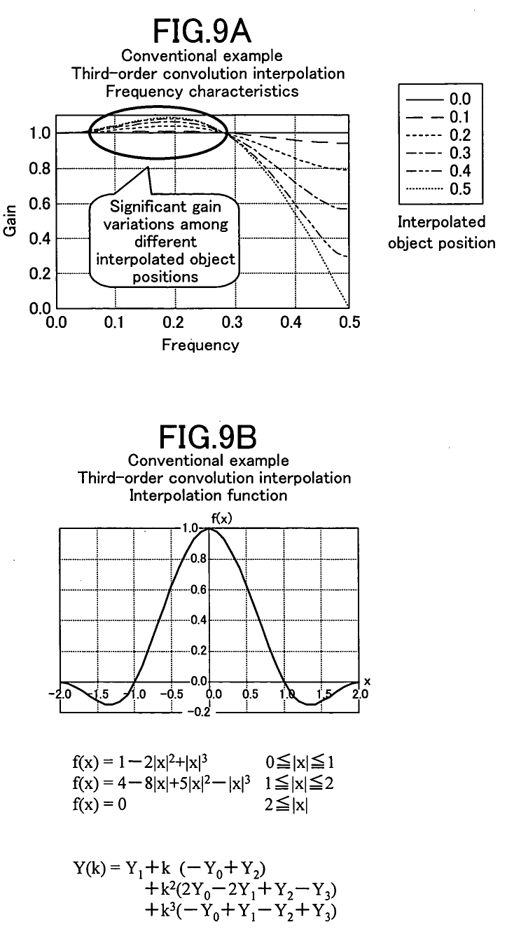

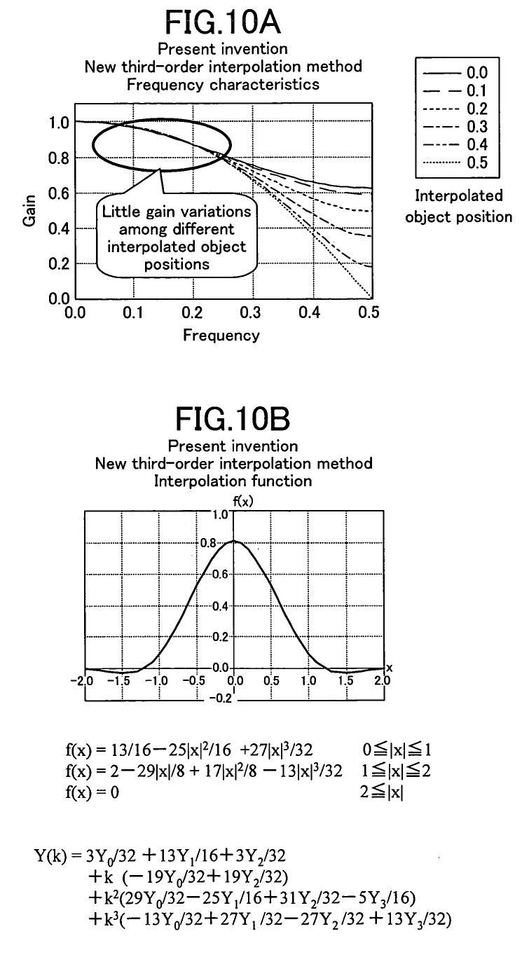

As an example, a camera shake compensation operation will now be described where the motion vector of the camera shake is 5/4 in the horizontal direction and 3/2 in the vertical direction. FIG. 5 shows the image coordinates before an interpolation operation, FIG. 6 shows the image coordinates after an interpolation operation, and FIG. 7 shows the coordinate data used for an interpolation operation. Assume that an interpolation operation for camera shake compensation is performed by using the image of FIG. 5 to obtain the 4×4 image of FIG. 6. In FIG. 6, the coordinates in each box are obtained by converting interpolated coordinates into uninterpolated coordinate values.

First, an interpolation operation is performed for the upper left pixel (hatched box) of FIG. 6. The interpolation operation is performed by using the coordinate values and the interpolated object positions (the decimal portions of the coordinates) in the corresponding box (hatched box) in FIG. 7. Specifically, Expressions 1 and 2 are calculated using the pixel values of the pixels (0, 0) to (3, 3) (hatched boxes) in FIG. 5, the vertical interpolated object position k_{V}=¼ therefor, and the horizontal interpolated object position k_{H}=½ therefor.

Then, the interpolation operation is performed for the next pixel to the right from the upper left pixel. In the interpolation operation, Expressions 1 and 2 are calculated using the pixel data of the pixels (0 to 3, 1 to 4) and the interpolated object positions k_{V}=¼ and k_{H}=½ therefor specified in the corresponding box in FIG. 7. Then, the interpolation operation is performed based on Expressions 1 and 2 for the next pixel to the right from the second pixel by using the pixel data of the pixels (0 to 3, 2 to 5) and the interpolated object positions k_{V}=¼ and k_{H}=½ therefor specified in the corresponding box in FIG. 7. This is repeated for the rest of the pixels to be interpolated, thereby obtaining a camera shake-compensated 4×4 image as shown in FIG. 6.

Generally, a camera shake compensation operation can be performed as follows. Assume that a camera shake compensation operation with r_{V} in the vertical direction and r_{H} in the horizontal direction is performed.

First, an interpolation in the vertical direction is performed. Assume that the vertical size of the image to be obtained is m_{V} pixels. Where the vertical start position of the interpolated pixels with no camera shake is s_{V}, the interpolated object pixel position P_{iV} is obtained as follows.
P_{iV}=s_{V}+r_{V}+i_{V}(i_{V}=0, 1, 2, 3, . . . , m_{V}−1)

Assume that the integer portion of P_{iV} is P_{int iV}, and the decimal portion thereof is P_{dec iV}. The data of the following coordinates
P_{int iV-1}, P_{int iV}, P_{int iV+1}, P_{int iV}+2
are used as the original data of pixels to be interpolated. Let the respective pixel data be represented as
Y_{iV-1}, Y_{iV}, Y_{iV+1}, Y_{iV+2}, and
let k_{V}=P_{dec iV}.
In the vertical interpolation, Expression 1 is calculated using these values. Repeating this for i_{V}=0, 1, 2, 3, . . . , m_{V}−1 yields an image in which the camera shake in the vertical direction r_{V} is compensated for.

Next, an interpolation in the horizontal direction is performed. Assume that the horizontal size of the image to be obtained is m_{H} pixels. Where the horizontal start position of the interpolated pixels with no camera shake is s_{H}, the interpolated object pixel position P_{iH} is obtained as follows.
P_{iH}=s_{H}+r_{H}+i_{H}(i_{H}=0, 1, 2, 3, . . . , m_{H}−1)

Assume that the integer portion of P_{iH} is P_{int iH}, and the decimal portion thereof is P_{dec iH}. The data of the following coordinates
P_{int iH}−1, P_{int iH}, P_{int iH}+1, P_{int iH}+2
are used as the original data of pixels to be interpolated. Let the respective pixel data be represented as
Y_{iH-1}, Y_{iH}, Y_{iH+1}, Y_{iH+2}, and
let k_{H}=P_{dec iH}.

In the horizontal interpolation, Expression 2 is calculated using these values. Repeating this for i_{H}=0, 1, 2, 3, . . . , m_{H}−1 yields an image in which the camera shake in the horizontal direction r_{H} is compensated for.

While there are various ways of determining the coefficients aᵢ, bᵢ, cᵢ and dᵢ of the interpolation function f(x), listed below are desired conditions for the interpolation function. Note that each of the following conditions is not a necessary condition for the interpolation function. All of the conditions may be satisfied, but it is not required to satisfy all of the conditions. Whether or not to satisfy each of the conditions can be determined in view of the balance between the interpolation filter characteristics and the influence of the change in cost by the increase/decrease in the circuit scale, for example.

Condition 1: n=2 and x₁=1.

Advantage: the computational cost is reduced, and the circuit scale is decreased.

Condition 2: fᵢ(0)=0.

Advantage: the gain step will be small for interpolated pixel positions around 0.

Condition 3: fᵢ(xᵢ₊₁)=fᵢ₊₁(xᵢ₊₁).
where f′ is f differentiated with respect to x.

Advantage: the gain step will be small for interpolated pixel positions around xᵢ₊₁.

Condition 4: the denominator of each of aᵢ, bᵢ, cᵢ and dᵢ is a power of two.

Advantage: the computational cost is reduced& and the circuit scale is decreased.

Condition 5: the gain is one or less across the entire frequency region of the subject image.

Advantage: there will be no aliasing.

Condition 6: where the frequency of the subject image is ⅕ or less of the frequency corresponding to the pixel pitch, the variation in gain according to the interpolated position falls within 5% of the maximum gain value for the frequency.

Advantage: there will be little gain variations among different interpolated pixel positions in a lower frequency range.

Alternatively, a plurality of sets of the coefficients aᵢ, bᵢ, cᵢ and dᵢ may be provided, one of which can be selected each time. This allows an optimal interpolation filter to be applied on each particular subject image data.

Alternatively, instead of storing the coefficients aᵢ, bᵢ, cᵢ and dᵢ, the filter may store 16 coefficients of A₀ to A₃, B₀ to B₃, C₀ to C₃ and D₀ to D₃ in the following expression representing the interpolated value Y where the interpolated object position is shifted from Y₁ toward Y₂ by k with respect to the sequence of uninterpolated pixel coordinates Y₀, Y₁, Y₂ and Y₃. This reduces the computational cost.
Y(k, Y₀, Y₁, Y₂, Y₃)==f(1+k)Y₀+f(k)Y₁+(1−k)Y₂+f(2−i k)Y₃=A₀Y₀+B₀Y₁+C₀Y₂+D₀Y₃+k(A₁Y₀+B₁Y₁+C₁Y₂+D₁Y₃)+k²(A₂Y₀+B₂Y₁+C₂Y₂+D₂Y₃)+i k³(A₃Y₀+B₃Y₁+C₃Y₂+D₃Y₃)

For example, where n=2 and x₁=1,

$$\begin{matrix}f ( 1 + k ) = {a}_{1} + {b}_{1} + {c}_{1} + {d}_{1} + \\ ( 3 {a}_{1} + 2 {b}_{1} + {c}_{1} ) k + \\ ( 3 {a}_{1} + {b}_{1} ) {k}^{2} + \\ {a}_{1} {k}^{3}\end{matrix}$$

$$\begin{matrix}f ( k ) = {d}_{0} + \\ {c}_{0} k + \\ {b}_{0} {k}^{2} + \\ {a}_{0} {k}^{3}\end{matrix}$$

$$\begin{matrix}f ( 1 - k ) = {a}_{0} + {b}_{0} + {c}_{0} + {d}_{0} - \\ ( 3 {a}_{0} + 2 {b}_{0} + {c}_{0} ) k + \\ ( 3 {a}_{0} + {b}_{0} ) {k}^{2} - \\ {a}_{0} {k}^{3}\end{matrix}$$

$$\begin{matrix}f ( 2 - k ) = 8 {a}_{1} + 4 {b}_{1} + 2 {c}_{1} + {d}_{1} - \\ ( 12 {a}_{1} + 4 {b}_{1} + {c}_{1} ) k + \\ ( 6 {a}_{1} + {b}_{1} ) {k}^{2} - \\ {a}_{1} {k}^{3} .\end{matrix}$$

Hence, the coefficients of these terms are given as follows.
A₁=a₁+b₁+c₁+d₁
A₂=3a₁+2b₁+c₁
A₃=3a₁+b₁
A₄=a₁
B₁=d₀
B₂=c₀
B₃=b₀
B₄=a₀
C₁=a₀+b₀+c₀+d₀
C₂=−3a₀−2b₀−c₀
C₃=3a₀+b₀
C₄=−a₀
D₁=8a₁+4b₁+2c₁+d₁
D₂=−12a₁−4b₁−c₁
D₃=6a₁+b₁
D₄=−a₁

Alternatively, a plurality of sets of the 16 coefficients A₀ to A₃, B₀ to B₃, C₀ to C₃ and D₀ to D₃ may be provided, one of which can be selected each time. This allows an optimal interpolation filter to be applied on each particular subject image data.

An interpolation operation for color signal processing will be described.

Where an image signal is formed by a luminance signal and a color-difference signal, it is necessary, for a YCrCb operation, for example, to perform an interpolation operation not only on the luminance signal but also on the color-difference signal. Then, an interpolation operation may be performed by using the interpolation function f(x) of the present embodiment both on the luminance signal and on the color-difference signal. For example, where the color-difference signals are not thinned out with respect to the luminance signal, a third-order interpolation operation of the present invention may be performed for all of Y, Cr and Cb. In contrast, where the color-difference signals are thinned out with respect to the luminance signal, an interpolation operation may be performed by using the interpolation function f(x) on the luminance signal, whereas a linear interpolation is applied on the color-difference signal.

Where the image signal is an RGB signal, an interpolation operation may be performed by using the interpolation function f(x) of the present embodiment on each of the R, G and B signals.

The present invention is useful in image signal processing devices, such as digital still cameras, video cameras and television sets, having a zooming function using an interpolation filter and a camera shake compensation function using an interpolation filter.

What is claimed is:

1. An interpolation filter for performing an interpolation operation on an image signal, wherein:
the interpolation filter outputs an output value, as a signal value at an interpolated object position, wherein the output value is obtained by multiplying each of signal values of pixels within a two-pixel distance from the interpolated object position by a coefficient and adding up the obtained products together; and
an interpolation function f(x), representing a coefficient by which a value of a pixel at a distance of x from the interpolated object position is multiplied, is given by the following expression (where f(x) is defined for each of n intervals obtained by dividing 0≦|x|≦2 into n portions, and k is a decimal portion of a coordinate of the interpolated object position).
fᵢ(x)=aᵢ|x|³+bᵢ|x|²+c₁|x|+dᵢ(xᵢ≦|x|<xᵢ₊₁)(i=0, 1, . . . , n−1, x₀=0, xₙ=2)
f₀(0)≠1
fᵢ(xᵢ₊₁)=fᵢ₊₁(xᵢ₊₁)
fₙ(2)=0
f(1+k)+f(k)+f(1−k)+f(2−k)=1 (0≦k≦1)

2. The interpolation filter of claim 1, wherein the interpolation function f(x) is determined so that where a frequency of a subject image is ⅕ or less of a frequency corresponding to a pixel pitch, a variation in gain according to the interpolated object positions falls within 5% of a maximum gain value for the frequency.

3. The interpolation filter of claim 1, wherein the interpolation filter stores 16 coefficients of A₀ to A₃, B₀ to B₃, C₀ to C₃ and D₀ to D₃ in the following expression representing an interpolated value Y where the interpolated object position is shifted from Y₁ toward Y₂ by k with respect to a sequence of uninterpolated pixel coordinates Y₀, Y₁, Y₂ and Y₃.
Y(k, Y₀, Y₁, Y₂, Y₃)=f(1+k)Y₀+f(k)Y₁+(1−k)Y₂+f(2−k)Y₃=A₀Y₀+B₀Y₁+C₀Y₂+D₀Y₃+k(A₁Y₀+B₁Y₁+C₁Y₂+D₁Y₃)+k²(A₂Y₀+B₂Y₁+C₂Y₂+D₂Y₃)+k³(A₃Y₀+B₃Y₁+C₃Y_{2+D}₃Y₃)

4. The interpolation filter of claim 3, wherein the interpolation filter stores a plurality of sets of the 16 coefficients, one of which can be selected each time.

5. The interpolation filter of claim 1, wherein n=2 and x₁=1.

6. The interpolation filter of claim 1, wherein the interpolation function f(x) is determined so as to satisfy the following expression.
fᵢ(0)=0

7. The interpolation filter of claim 1, wherein the interpolation function f(x) is determined so as to satisfy the following expression.
fᵢ(xᵢ₊₁)=fᵢ₊₁(xᵢ₊₁)

8. The interpolation filter of claim 1, wherein the coefficients aᵢ, bᵢ, cᵢ and dᵢ in the interpolation function f(x) are determined so that a denominator of each of the coefficients is a power of two.

9. The interpolation filter of claim 1, wherein the interpolation function f(x) is determined so that a gain is one or less irrespective of a value of a frequency of a subject image.

10. The interpolation filter of claim 1, wherein:
the image signal is formed by a luminance signal and a color-difference signal; and
the interpolation filter performs an interpolation operation using the interpolation function f(x) on each of the luminance signal and the color-difference signal.

11. The interpolation filter of claim 1, wherein:
the image signal is formed by a luminance signal and a color-difference signal; and
the interpolation filter performs an interpolation operation using the interpolation function f(x) on the luminance signal, whereas the interpolation filter performs a linear interpolation on the color-difference signal.

12. The interpolation filter of claim 1, wherein:
the image signal is an RGB signal;
the interpolation filter performs an interpolation operation using the interpolation function f(x) on each of the R, G and B signals.

13. An image signal processing device, comprising the interpolation filter of claim 1.
